(19) United States
(12) Patent Application Publication
(10) Pub. No.: US 2009/0071334 A1
(43) Pub. Date: Mar. 19, 2009

(54) Convenient Substance-Recovery System and Process

(75) Inventor: Jae Ryu, Carlisle, MA (US)

Correspondence Address: MODERN TIMES LEGAL, ONE BROADWAY , 14TH FLOOR, CAMBRIDGE, MA, 02142, US

(73) Assignee: Aspen Systems, Inc., Marlborough, MA (US)

(21) Appl. No.: 12/139,817

(22) Filed: Jun. 16, 2008

Related U.S. Application Data
(60) Provisional application No. 60/945,621, filed on Jun. 22, 2007.

(51) Int. Cl. B01D 53/04

(52) U.S. Cl. 95/117; 96/153

(57) ABSTRACT

A polar-substance-permselective membrane includes a porous support and an active-membrane material. The active-membrane material fills the pores of the porous support to render the support substantially impermeable to non-polar gases at a moderate pressure gradient (e.g., at least 70 kPa) when the hydrophilic active-membrane material is wet. In a particular embodiment the membrane is water-permselective and the active-membrane material is hydrophilic. Water-recovery system and processes utilizing these water-permselective membranes can be used to selectively remove water from hot gas streams at the feed side, and collect water at the permeate side with extremely high energy efficiency. The membrane is particularly useful for in-situ extraction of water molecules directly from hot exhaust streams. The produced steam, or steam and air mixtures can be used as a feedstock in the process of converting liquid hydrocarbons into hydrogen-rich gas streams.

### RELATED APPLICATION

This application claims the benefit of U.S. Provisional Application No. 60/945,621, filed Jun. 22, 2007, the entire content of which is incorporated herein by reference.

### GOVERNMENT SUPPORT

The invention was supported, in whole or in part, by a grant, under Contract No. FA8650-05-M-5819, from the United States Air Force. The Government has certain rights in the invention.

### BACKGROUND

Because of their high efficiency and environmental acceptability, fuel-cell technologies are attractive for power generation. Intensive research efforts toward developing fuel-cell-based power generation systems have been revitalized both by worldwide concern about the environment and by government regulations. Most of the technologies and subsystems for fuel cells are currently well established. However, supplying fuel for fuel cell operation poses a significant logistical challenge for many intended uses of fuel-cell power-generation systems.

Liquid hydrocarbon fuels (such as diesel, jet fuel and gasoline) are the predominant fuels for mobile and remote-site electric-power-generation systems, which can be used, e.g., in military operations. Consequently, extensive efforts have been enlisted to develop a reforming process to produce hydrogen-rich gaseous fuels (for use in fuel cell operations) from liquid-hydrocarbon fuels. Diesel and jet fuels, however, are two of the most difficult fuels to convert into hydrogen-rich gaseous fuels for fuel-cell operations. Various aromatic compounds contained in the liquid-hydrocarbon fuels have a tendency to coke and generally require high temperatures for fuel reforming.

In order to overcome the technical challenges associated with reforming military logic fuels, many innovative technologies and processes have been under development. As a result of these intensive efforts, limited successes have been achieved in reforming logistic fuels for fuel cell operations [see M. Krumpelt, et al., Catalysis Today, 77, 3 (2002).; J. Ryu, “Convenient Method of Generating High Purity Hydrogen from Logistic Fuels”, Gordon Research Conf., CHEMISTRY OF HYDROCARBON RESOURCES, Ventura, Calif. (January 1999); and D. W. Matson, et al., “Fabrication of Microchannel Chemical Reactors Using a Metal Lamination Process”, Microreaction Technology: Industrial Prospects, Third Int'l Conference Microreaction Technology (1999)].

Two main processes for reforming liquid hydrocarbons are steam reforming and partial oxidation (POX). In steam reforming, liquid hydrocarbons and water (in the form of steam) react to form a gas mixture of hydrogen (H₂), carbon dioxide (CO₂) and carbon monoxide (CO). This reaction is endothermic and, therefore, requires heat. Theoretically, 75% of the resulting gas mixture is useful fuel (H₂ and CO). In the partial-oxidation process, liquid hydrocarbons and oxygen react to produce H₂, CO and CO₂. If air is used as an oxygen source, about 50% of the resulting gas mixture is nitrogen. The partial-oxidation process is an exothermic process. Combination of these two processes results in a process known as autothermal reforming (ATR), which neither produces nor requires heat. The exotherm of the partial-oxidation reaction can generate temperatures in excess of 800° C., where reforming catalysts rapidly sinter, thereby reducing their lifetime. Any localized hot spot also leads to catalyst degradation and deactivation via carbon formation. Consequently, long-term durability and process reliability are the two main problems associated with the partial-oxidation fuel-reforming process even though the partial-oxidation process is much simpler and more amenable to smaller packaging for the reforming process than is the steam-reforming process.

The process reliability of the partial-oxidation process can be significantly improved by adding steam (water) into the reformer feedstock via the autothermal-reforming process. Water addition also helps to reduce carbon formation during the liquid-fuel reforming process. For many remote sites and mobile applications, however, supplying the water (in particular, clean water) is a significant problem. Consequently, recycling the exhaust from fuel cells-especially the anode exhaust stream of a solid oxide fuel cell (SOFC), which contains a significant amount of water—has been investigated by many groups in the last few years [see R. L. Borup, et al., “Diesel Reforming for Solid Oxide Fuel Cell Auxiliary Power Units”, DOE Annual Report, Office of Fossil Energy Fuel Cell Program, (2004); and J. R. Budge, et al., “Distillate Fuel Reformer Development for Fuel Cell Applications”, 5^{th} Annual DOD Fuel Processing Conference, Panama City, Fla., (January 2005)]. Recycling the anode exhaust, however, dilutes the hydrogen content in the reformate stream-consequently reducing overall system efficiency and specific power density.

Typically, the exhaust stream from a fuel cell contains significant water content—e.g., about 40-70% by volume and 20% by volume, respectively, in the SOFC anode exhaust stream and in the cathode exhaust stream of a proton exchange membrane fuel cell (PEMFC). The fuel reformate stream also contains a significant amount of water (e.g., 15-30% by volume), depending on the fuel-reforming processes. If the water in the fuel-cell exhaust stream or reformate stream can be effectively recovered and used as a reformer feed, a more-efficient and more-reliable liquid-fuel-reforming process can be designed, and the overall energy efficiency of the fuel cell can be greatly improved. Furthermore, removing water from the reformate stream will increase the hydrogen concentration in the stream of fuel gas flowing into the fuel cell anode, thereby significantly improving the specific power density.

An example of water recovery by employing a water-permselective membrane for a PEMFC power-generation operation is shown in FIG. 1. As shown in FIG. 1, a stream of liquid hydrocarbon fuel 30 is fed into a partial-oxidation, steam/autothermal reformer 32. Additionally, cold and dry air 34 for start up of partial oxidation also is fed into the reformer 32. A fuel reformate stream 36 from the reformer 32 is fed into a water-recovery system 38. Water 40 recovered from the fuel reformate stream 36 is circulated back into the reformer 32 for steam/autothermal reforming. The fuel reformate stream 36 exiting the water-recovery system 38 is fed into the anode 42 of a proton exchange membrane fuel cell 44 that produces electric power 56. An anode exhaust stream 46 comprising the resulting product of the fuel reformate stream 36 after passing through the anode 42 exits the fuel cell 44 on its opposite side. Pre-heated air 48 is fed through the cathode 50 of the fuel cell 44 and exits the opposite side as a heated exhaust stream 52 containing by-product water. The heated exhaust stream 52 then passes through the water-recovery system 38, where it releases water and heat, and exits as a cold exhaust stream 54. Water 40 recovered from the cathode exhaust stream 52 is circulated back into the reformer 32 for steam/autothermal reforming.

In addition, significant progress has recently been made in developing solid acid fuel cells (SAFC's) for operation at an intermediate temperature (e.g., 150-300° C.) [see D. A. Boysen, et al., “High-Performance Solid Acid Fuel Cells Through Humidity Stabilization,” Science, 303, p. 68, (2004)]. Because of their CO-tolerant nature, solid acid fuel cells greatly simplify the schematics and components for liquid-fuel processing. However, solid acid fuel cells require high-humidity environments around electrolytes. Consequently, effective water management is an important technology for solid acid fuel cells.

The conventional method of separating or removing water from hot gas streams is to condense steam into water by reducing the temperature of the steam-containing hot gas streams to below the boiling point of water. For example, U.S. Pat. No. 6,312,842 B1 describes a water-retention system to enhance the water balance and energy efficiency of a fuel cell power plant by employing an air-conditioning unit and condensing heat-exchanger loops. In this operation, however, significant energy was used to operate the air conditioning unit. Consequently, the overall system became bulky, and the overall process became complicated. U.S. Pat. No. 6,759,154 B2 describes a process of recovering water from the fuel-cell exhaust by using an air conditioning unit to condense water and then feeding the condensed water into the hydrocarbon reformer.

The process of condensing water from a hot gas stream involves significant cooling energy to reduce the temperature of the entire gas stream. A vapor-to-water phase change for steam also involves significant cooling energy. The conventional method of steam condensation and removal is, therefore, highly energy intensive. Furthermore, the overall efficiency of the condensation process is greatly influenced by the heat-exchanger design and heat-exchange process efficiency. Consequently, steam condensation systems with heat exchangers can be very bulky; and the entire process can be complicated. Effective management of water and heat in fuel-cell power plants has been previously described utilizing porous membrane structures. For example, U.S. Pat. Nos. 6,274,259 and 6,475,652 describe the use of a fine-pore enthalpy exchange barrier to exchange water and heat as the water and heat exit a plant and directing the water and heat back into the plant to enhance water balance and energy efficiency. The fine-pore enthalpy exchange barrier includes a support matrix that defines hydrophilic pores having a pore size in the range from about 0.1 to about 100 microns. The matrix is capable of being wetted by a liquid transfer medium resulting in a bubble pressure that is greater than 0.2 pounds per square inch (psi) (1.38 kPa); and the matrix is chemically stable in the presence of the liquid medium. The liquid transfer medium includes water, aqueous salt solutions, aqueous acid solutions, and organic antifreeze water solutions; and the transfer medium is capable of sorbing a fluid substance consisting of polar molecules, such as water, from a fluid stream consisting of polar and non-polar molecules. In this approach, movement of the water and heat from the hot exhaust stream into the cold inlet stream is primarily driven by a difference in the partial pressure of the water molecules within the hot exhaust stream and the partial pressure of water within the cold inlet stream, and by a difference in temperatures between the two streams. Furthermore, there is a trade-off between bubble pressure and liquid permeability; and the minimum bubble pressure necessary to allow maximum liquid permeability is utilized.

While the above approaches may be useful to a degree to recover water and heat from hot exhaust streams, these approaches have many limitations and disadvantages. For example, the enthalpy exchange barrier of the above-referenced patents needs relatively large hydrophilic pore sizes, typically greater than 0.1 microns, to achieve high water or liquid permeability. The large pore size greatly reduces bubble pressure to maintain gas impermeability through the enthalpy exchange barrier. Consequently, the differential pressure between the inlet and exhaust streams has to be precisely controlled, and the practical application of the enthalpy barrier is greatly limited. Furthermore, detailed performance results, such as water-recovery efficiency, for the fine-pore enthalpy barrier have not been provided.

### SUMMARY

A polar-substance-permselective membrane for selective removal of a polar substance, such as steam, from a hot gas stream comprises a porous support and an active-membrane material coating the pores of the porous support. The active-membrane material renders the porous support substantially impermeable to non-polar gases at a moderate pressure gradient [i.e., substantially impermeable at least with a pressure gradient of at least 10 psi (about 70 kpa)—for example, in the range from 20 to 50 psi (138 kPa to 345 kPa)] when the active-membrane material is wet. For a water-permselective membrane, the active-membrane material is hydrophilic.

The water-permselective membranes can have a composition that is compatible with elevated temperatures and chemically inert to liquid-fuel reformate and to fuel-cell exhaust streams. In particular embodiments, the hydrophilic active-membrane material is a hydrophilic nanoporous inorganic gel formed, e.g., of silica with an average pore size less than 100 nm. In other embodiments, the hydrophilic active-membrane material includes a polymeric material, poly(vinyl alcohol), that is stable at temperatures of at least 100° C. In additional embodiments, the hydrophilic active-membrane material includes nanocomposite structures of a hydrophilic material (with the hydrophilic materials having at least one dimension less than 100 nm), such as silica or molecular sieve carbon embedded with titania or zeolite nanoparticles (having, e.g., a diameter between 0.1 and 10 nm).

The average pore size of the porous support can be about 0.2 microns; and in additional embodiments, the hydrophilic active-membrane material is substantially impermeable to non-polar gases at pressure gradients of 10 to 100 psi (69 to 690 kPa) when wet.

In a process for selective removal of steam from a gas mixture, the gas mixture flows across the surface of a water-permselective membrane, as described above, wherein the gas mixture contacts the hydrophilic active-membrane material. Water from the gas mixture is adsorbed to the hydrophilic active-membrane material and is transported across the water-permselective membrane. The water is then removed from the permeate side of the water-permselective membrane (on the opposite side of the water-permselective membrane from the surface that contacts the gas mixture).

The properties of the main flow streams, such as temperature and pressure, need not change significantly. Consequently, this membrane-based separation can be carried out as a highly energy-efficient process.

In additional embodiments, a high-energy-efficiency water-recovery system and process employ the above-described water-permselective membranes. The process parameters of (a) overall water-recovery system efficiency, (b) process reliability, and (c) optimum water recovery can all be tailored to the required water-recovery system-performance specifications by managing the following parameters: (1) the configuration of the water-permselective-membrane; (2) the selection of hydrophilic coating materials; and (3) the schematics of the water-recovery-process.

The resulting water-permselective-membrane-based water-recovery system for producing water from hot gas streams can be compact, versatile, and low-cost, and can operate with little or no parasitic power consumption.

In the water-recovery system, the active component of the water-permselective composite membrane has very fine pore sizes (e.g., in a range from about 1 to about 100 nm). For membranes with such small pore sizes, water molecules diffuse through the membrane via a surface diffusion mechanism. In this case, the hydrophilicity of the pore surface can determine the permeability of water through the membrane. Furthermore, differential pressure across the membrane does not significantly affect the water permeability through the membrane; while absolute pressure of the exhaust stream (feed-side) is an important parameter for effective adsorption of water molecules onto the membrane surface. The water-permselective composite membrane, disclosed herein, can be used to recover water and heat more effectively and reliably and from various process stream conditions.

The in-situ water-recovery process and device, which are described herein, can also be effectively used to produce a preheated air stream with controlled humidity for a solid-acid fuel-cell system.

In processes of this disclosure, steam in the hot gas stream reacts with a hydrophilic active-membrane layer and is collected at the permeate side. Furthermore, water can be recovered as hot steam via the pervaporation principle (membrane permeation and evaporation) as a potential feedstock for the stream-reforming process. If a steam/air mixture is preferable for the autothermal-reforming process, water can be recovered by using an air sweep via a surface diffusion mechanism. In this membrane-based process, no active cooling of the hot gas stream is necessary to condense and collect water. Furthermore, the resulting products can be either hot steam or preheated wet air, depending on the requirements for the collected water. Consequently, high overall system and process efficiencies can be achieved.

### BRIEF DESCRIPTION OF THE DRAWINGS

FIG. 1 shows an embodiment and process schematic of a water-recovery system with a liquid-fuel reformer and a proton-exchange-membrane fuel-cell system.

FIG. 2 is a schematic illustration of an embodiment of the water-permselective membrane module.

FIG. 3 is a schematic illustration of an embodiment of the water-recovery system using the water-permselective membrane.

FIGS. 4 and 5 represent two embodiments of water-recovery process schematics.

FIG. 6 is a schematic illustration of an embodiment of a water-recovery membrane module in a planar configuration, where each active-membrane layer is structurally supported by porous stainless steel or ceramic plates, and where each active-membrane layer comprises ceramic-fiber-reinforced hydrophilic filler materials.

FIG. 7 is a chart showing water-recovery efficiency as a function of the steam content in the feed stream; the process stream temperature entering the membrane module was 180° C. in these experiments.

FIG. 8 is a chart showing the temperature profiles of various streams in the water-permselective-membrane-based water-recovery process, wherein the top line represents the temperature of the inlet feed stream; the middle line represents the temperature of the permeate stream; and the bottom line represents the temperature of the exhaust stream.

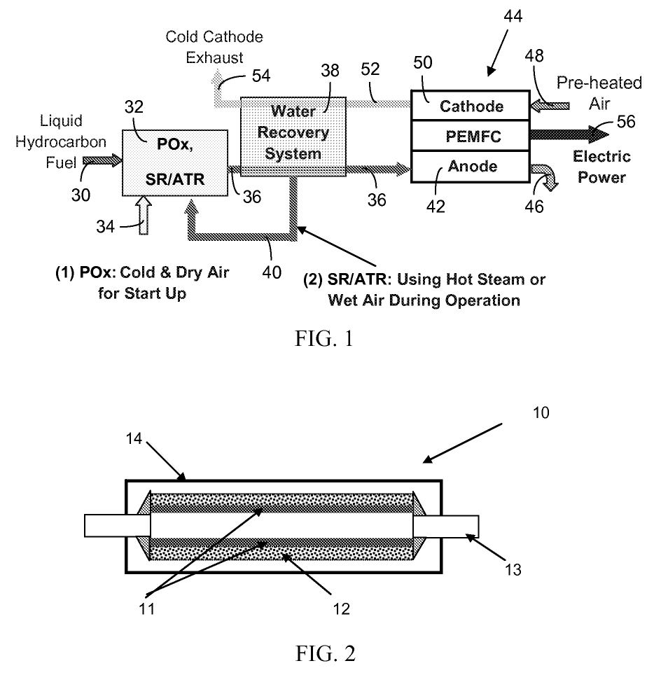

### DETAILED DESCRIPTION

The principles discussed herein can be employed to selectively remove a variety of substances, though the focus here is primarily on membranes for the selective removal of water. Water-permselective membranes are membranes that allow a high flux of water therethrough while reducing or eliminating the flux of other species. Water-permselective membranes of this disclosure contain hydrophilic centers that selectively adsorb water molecules from streams of hot gas mixtures (e.g., at a temperature of 100° C. or more). The adsorbed water molecules are transported across the membrane thickness via surface diffusion through hydrophilic centers in the membranes. “Hydrophilic centers” in the membranes include water-adsorbing surface bonding or ionic centers, such as hydroxyl groups, amine groups, carboxyl groups, etc., whereby the water molecules can be transported across a string of these functional groups through the membrane.

At the permeate side of the water-permselective membrane, the water molecules are desorbed via cold air sweeping or pervaporation, depending on the process. To achieve high water-recovery efficiency and selectivity, the water-permselective membranes are substantially impermeable to non-polar gases at operating pressure ranges (i.e., a non-zero number of non-polar gas molecules may pass through the membrane, though the amount of gas can be considered negligible—e.g., the partial differential gas pressure for the non-polar gases across the membrane changes by less than 0.1% over an hour), and the water-permselective membranes have a high density of hydrophilic centers uniformly distributed throughout the membranes. The membranes can have either a tubular or planar geometry, depending on the water-recovery system specifications.

As shown in FIG. 2, the water-permselective membrane module 10 in the tubular geometry includes water-adsorbing active-membrane layers 11 and a porous support 12. As a porous support tube, porous 316 stainless-steel tubes (available, e.g., from Mott Corporation of Farmington, Conn., United States) with various pore sizes and tube diameters can be used. In particular embodiments, the average or median pore size is about 0.2 μm. The 24-inch-long (61-cm-long) porous tubes can be cut into 6- to 12-inch-long (15- to 30-cm-long) pieces, depending on the tube diameter. ⅜-inch (1-cm) outer-diameter (OD) solid 316L stainless-steel tubes 13 are tungsten-inert-gas (TIG) welded onto both ends of the porous tube to be used for mounting the membrane onto the water-recovery membrane housing 14. In this particular example, the membrane is designed to be mounted onto a ¾-inch (2-cm) outer-diameter stainless-steel tube membrane housing.

For water-adsorbing hydrophilic membrane layers, three different types of active-membrane materials can be used based on their suitable operating temperature ranges, which include low-temperature applications (e.g., around 100° C.); moderate-temperature applications (e.g., 100-250° C.) and high-temperature applications (e.g., greater than 200° C.). These temperature ranges also reflect the temperatures of the hot gas streams from which the water is extracted by the membrane. Methods for producing these active-membrane layers on a porous substrate include solution casting and are further described in the Examples, infra.

For the low-temperature applications (around 100° C.), cross-linked polyacrylamide family copolymers, known as super-absorbent polymers (SAP's), can be used for the hydrophilic active-membrane layer. The super-absorbent polymers can absorb water in amounts that are hundreds of times greater than the mass of the super-absorbent polymers; super-absorbent polymers can also absorb water in a vapor state. The cross-linked structure of super-absorbent polymers provides a relatively high melting point of 200° C., chemical inertness and environmental stability. The super-absorbent polymers can be incorporated into a silica-gel matrix to form the hydrophilic active-membrane layer.

For moderate-temperature applications (e.g., 100-250° C.), polymeric superacids, such as sodium carboxymethyl cellulose and poly(vinyl alcohol), can be used to fabricate the active-membrane layer. The polymeric superacids have a variety of chemical structures and exhibit a number of outstanding properties, including high acid-equivalent values (acid numbers of several hundred in one polymer chain), outstanding thermal stability, and high glass-transition temperature. Cellulose is a very stable material; accordingly, there is no solvent that can be used to make cellulose solution. Sodium carboxymethyl cellulose has all the chemical and thermal stability possessed by cellulose (the melting point of sodium carboxymethyl cellulose is 270° C., and it can be used up to 220-250° C.); and sodium carboxymethyl cellulose also is water-soluble. With different molecular weights and degrees of substitution (content of carboxylic groups), the hydrophilic nature (i.e., polarity and consequent water-absorbing capability) and elevated-temperature stability of this material can be controlled. For example, the material can be made more hydrophilic by adding more polar functional groups (such as OH⁻), while increases in molecular weight can provide stability at higher temperatures. These polymeric superacids can be incorporated into a silica-gel matrix to form the hydrophilic active-membrane layer.

Poly(vinyl alcohol) (PVA) is also a highly hydrophilic polymer that has been widely used to make hydrogels and which can be used as the active-membrane material. The structure of poly(vinyl alcohol) is very simple, and it is chemically and thermally stable (i.e., it can be used up to 180° C.). If necessary, carboxymethyl cellulose (CMC) and poly(vinyl alcohol) can be cross-linked into water-insoluble materials. Poly(vinyl alcohol) is water-soluble, and membrane modules made from these hydrogels were structurally strong. Initial screening test results indicated that membrane modules made of PVA were structurally more stable than were those of the CMC at elevated temperatures (150° C.).

For high-temperature applications (e.g., at temperatures greater than 200° C.), coating materials that are inorganic and hydrophilic (charge-polarized and capable of hydrogen bonding), such as silica gels with embedded hydrophilic centers, have been developed for use as the active-membrane material. In particular, silica aerogels or xerogels are nanostructured (e.g., with pores smaller than 100 nm in diameter, though a minority of larger-sized pores may be found therein), highly porous (e.g., having a porosity of 90% or more), and stable at relatively high temperatures (e.g., up to temperatures of at least 400-450° C.). In xerogels, liquid remains in the pores. These silica gels and other hydrophilic inorganic materials, such as zeolite particles, are also effective as active-membrane materials for moderate-temperature applications (e.g., at temperatures in the range from 100-250° C.). In particular embodiments, zeolite particles or hydrophilic polymers are contained in a silica gel matrix to enhance water permeability and durability at relatively low temperatures. In this case, the hydrophilic polymer or zeolites provide additional hydrophilic centers.

These silica gel materials were fabricated via hydrolysis and condensation processes and were easily fabricated into thin coatings. In order to improve the durability of the silica gels, fiber filament materials can be added during gelation and coating procedures. The hydrophilic nature and structural strength of the silica gels can be controlled (a) by controlling surface functional groups (e.g., a higher density of polar functional groups can increase the hydrophilicity of the gel), (b) by embedding secondary hydrophilic elements (to increase hydrophilicity) and (c) by controlling the amount of fiber filament materials (e.g., more fiber filaments can increase structural strength).

U.S. Pat. No. 6,239,243 describes a two-step method for preparing hydrophilic silica gels with high pore volume. In the first step, a hydrophobic silica gel is produced by treating a silica gel with an organosilicon compound in the presence of a catalytic amount of a strong acid. In the second step, the hydrophobic silica gel is heated in an oxidizing atmosphere at a temperature sufficient to reduce the hydrophobicity imparted by the surface treatment, thereby producing a more-hydrophilic silica gel having high pore volume.

The method, described in Example 1, can conveniently produce hydrophilic silica gels that exhibit superior water permselectivity at elevated temperature by utilizing a partially hydrolyzed organic silica precursor. The hydrophilicity and pore size of silica gels are greatly affected by the molar ratio between organosilicon precursor, alcohol, and water, and by the pH of the solution due to hydrolysis reaction [C. J. Brinker, et al., Ultrastructure Processing of Advanced Materials, Wiley, New York, p. 211 (1992)]. Therefore, by carefully controlling the molar ratio of silica gel precursors, the hydrophilicity and pore size of the resulting silica gel can be manipulated.

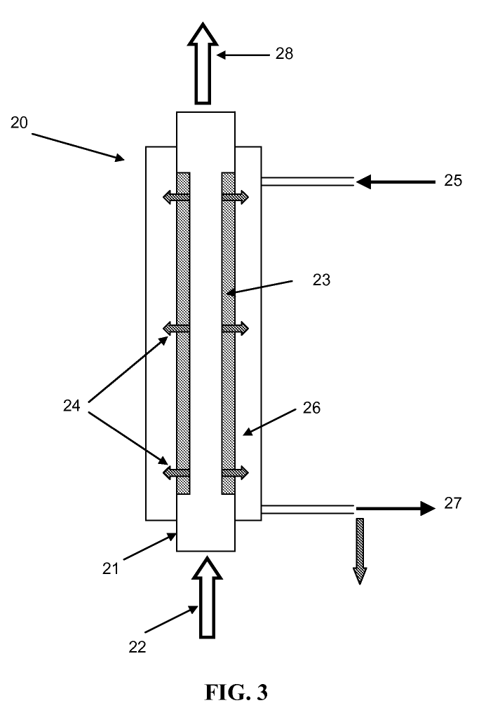

A water-recovery system and process 20 is schematically shown in FIG. 3. A membrane module 21 has a tubular geometry with a ⅜-inch (1-cm) outer diameter (OD) and ¼-inch inner diameter (ID). In the membrane module 21, hot gas streams 22 having various temperatures and steam contents are fed into the inner side of the membrane module, which has a hydrophilic active-membrane layer 23. At the membrane layer 23, steam 24 in the hot gas stream is selectively captured via adsorption, permeated through the membrane layer 23, and recovered (collected) at the permeate side 26. In this particular example, a cold air sweep through a sweep-air inlet 25 is used to remove water at the permeate side 26. In this unique water-recovery process, both steam (water) and heat are collected at the sweep-air outlet 27. The main gas stream with significantly reduced steam content and temperature is exhausted through the membrane outlet 28.

Water can be recovered as pure steam, as condensed water, or as a mixture of hot air and condensed steam, depending on the method used to desorb water from the permeate side of the membrane. By creating reduced pressure (vacuum) on the permeate side, pure steam or water can be desorbed from the permeate side 24 of the membrane 10, as shown in FIG. 4. In order to create reduced pressure at the permeate side 24, a vacuum pump 60 can be used. A blower and pump located between the water-recovery system and the fuel reformer can feed the pure steam or water product into the reformer unit and create reduced pressure at the permeate side 24 of the membrane 10.

If wet (moisturized) air is a desirable byproduct from the water-recovery system 20, water can be desorbed from the water-permselective membrane 10 by using cold sweep air 25, as shown in FIG. 5. During water sweeping, air will be preheated to elevated temperatures, as well. This preheated and wet air 27 can be fed directly to the fuel reformer, which can be, e.g., an autothermal-reforming or partial-oxidation processor. As such, the water-permselective-membrane-based water-recovery system is highly energy efficient, extremely compact and versatile.

For other applications, flow of other inert and hygroscopic substances, such as liquid- or vapor-phase alcohol or salt, or any mixture of these substances, can be used as a sweeping medium in this process. Where a salt is used, the salt can be precipitated after sweeping to separate it from the water by lowering the temperature of the stream.

A similar concept and similar water-recovery system can be used to recover steam from SOFC anode exhaust. Because of the high temperature of the SOFC exhaust stream (e.g., at a temperature between 300-600° C.), however, the polymer-based hydrophilic materials may not be suitable for use as an active-membrane material in this embodiment. For a high-temperature water-adsorbing membrane, hydrophilic inorganic active-membrane materials with fine pore sizes (e.g., less than 100 nm across), such as silica gels, zeolite nanoparticles and titania-containing molecular sieve carbon (MSC) nanocomposites, can be used. Zeolite (hydrated aluminosilicate) and titania (titanium dioxide) are stable at high temperatures and highly hydrophilic. Therefore, the nanocomposites of zeolite or titania embedded into the molecular sieve carbon or other porous inorganic matrix can provide water-adsorbing properties at high temperatures. The molecular sieve carbon serves to increase the strength and high-temperature stability of the active-membrane material.

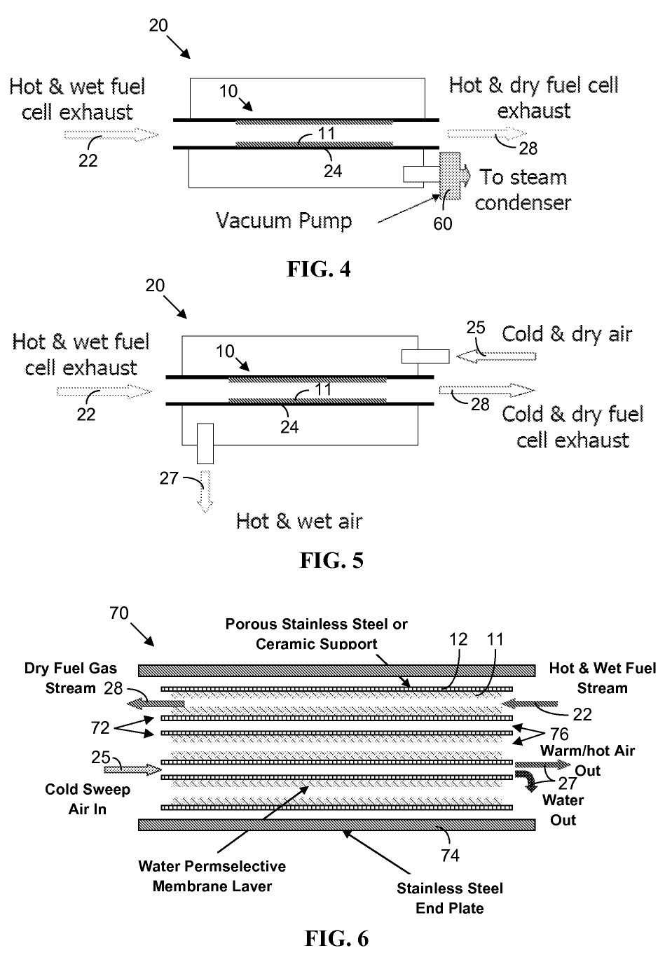

The water-permselective membrane module can have a planar configuration, as is schematically shown in FIG. 6. In this structure 70, each water-permselective membrane plate 72 includes a porous/perforated metal or ceramic plate 12 and a ceramic-fiber-reinforced inorganic hydrophilic layer 11. Where the porosity in the support plate 12 is provided in the form of perforations, the perforation holes can have a diameter, e.g., of 1/32 to ¼ inch (0.8 mm to 6.4 mm). The membrane plates 72 can be stacked together using graphite gaskets and mechanical compression seals using end plates 74. Gaps 76 between the membrane plates 72 can be controlled by using spacers. The planar membrane geometry is greatly beneficial toward achieving high specific power densities, specific volume and specific weight. Furthermore, the planar-geometry membrane module is also favorable to improve other water-recovery system and process parameters, such as by reducing pressure drop across the water-recovery system (membrane module), minimizing the water molecule channeling effect so that more of the water molecules in the flow between the membrane plates collide with and are adsorbed onto the surface of the active-membrane material [by providing a small gap between membrane plates, such as a gap of 0.0625 inch (1.6 mm) or smaller], increasing the modularity of the system, etc.

The facilitated membrane-based process, described herein, is also applicable for separating small concentrations of valuable components from complex vapor mixtures. For example, when producing biofuels, such as ethanol and acetone from biomass, distillation and pervaporation are the most widely used industrial processes. By utilizing the membrane-based process, described herein, with a hydrophobic active membrane layer, the ethanol and acetone can be selectively extracted from the biomass process streams. The hydrophobic membranes can have a composition similar to the hydrophilic membranes, except with different surface groups to provide hydrophobicity, as can be produced when the silica precursor is subjected to different process conditions, as described in U.S. Pat. No. 6,239,243; for example, a silica gel can be treated with an organosilicon compound in the presence of a catalytic amount of a strong acid to render it hydrophobic.

### EXEMPLIFICATIONS

### Example 1

Water-permselective membranes that were substantially impermeable to non-polar gases were produced first by impregnating nanoporous silica wet gels (with pores having a diameter less than 100 nm) into porous inorganic supports. Stainless-steel support tubes having 0.2-10 micron pore size (supplied by Mott Corporation of Farmington, Conn.) were used as the structural supports. The silica wet gels were fabricated by using conventional silica aerogel processing without going through the supercritical drying step. In this example, a pre-condensed tetraethyl orthosilicate (TEOS), such as SILBOND H-5 TEOS (available from Silbond Corp. of Weston, Mich., United States), was used as the silica precursor. The SILBOND H-5 TEOS has about 20 weight percent of SiO₂ in ethyl alcohol (ethanol).

An example of a fabrication procedure by which silica wet gels were impregnated into the porous support is provided as follows. First, SILBOND H-5 TEOS was mixed with ethanol and water in a volume ratio of 10:4:2. After mixing for 30 minutes, ammonia catalyst (30% ammonia concentration by volume in water) was added into this mixture while stirring to produce about 0.001-0.002 volume-% ammonia in the resulting mixture. Immediately, the silica sol and catalyst mixture solution was then poured into the porous stainless-steel tube, which was sealed on one end. The other end was then connected to a line coupled with a source of pressurized gas, such as high-purity nitrogen, and gradually pressurized until liquid began sweating at the other side of the porous stainless-steel support. Typically, the sweating occurred at applied pressures of 2-5 pounds per square inch (psi) (14 to 34 kPa) for the first layer. After pressurizing, the remaining solution was then decanted; and the support, which was then filled and coated with silica wet gel, was air dried and gelled in ambient conditions for 30 minutes to 2 hours, followed by aging at elevated temperatures using a sealed aging container. A typical temperature and time for aging the silica gel was 60° C. for 12-24 hours.

A higher volume percentage (i.e., 62.5 volume-%) of the SILBOND H-5 TEOS was used in this example than is used in a typical silica gel formulation of 31 volume-% of SILBOND H-5. In order to facilitate hydrolysis of the organosilicate precursor and increase the pot-life of the silica precursor mixture, the SILBOND H-5 TEOS was pre-mixed with a controlled amount of water; and the pre-mixed solution was aged for 3-50 days before using it for the silica-gel processing, mentioned above. Typically, 0.1-30 volume-% of water was added into the SILBOND H-5 for premixing.

These processes for silica gel coating and aging were repeated until no silica gel precursor leaked through the porous supports at a back pressure of 10-50 pounds per square inch gauge (psig) (170 kPa to 446 kPa). Generally, 2-5 layers of silica coatings were formed to produce substantially non-polar-gas-impermeable membrane modules with the current silica-gel formulations and processing conditions. The number of silica-gel coating layers formed to achieve the substantially gas-impermeable condition can be adjusted, if necessary, by varying the pore size of the supports (e.g., fewer coatings can be used with smaller pores), varying the solid content in the silica gel precursors (e.g., fewer coatings can be used with higher solid contents), etc.

### Example 2

In order to produce a durable water-permselective membrane layer, the mechanical strength of the silica gel can be improved by incorporating fiber filaments into silica sols. To commence this modified silica-gel-fabrication process, 1 g of quartz fiber (available from Schuller International, Denver, Colo., United States) was dispersed and mixed overnight in 100 ml of ethanol. Silica sol containing quartz fiber was produced by mixing SILBOND H-5 TEOS with the quartz/ethanol mixture and water in a volume ratio of 10:4:2, respectively. After 30 minutes, 0.001-0.002 volume-% NH₄OH catalyst was added into this mixture while stirring. This silica sol and catalyst mixture solution was then pipetted into the porous stainless-steel tube, which was sealed on one end. The other end was then connected to an ultra-high purity (UHP) N₂ gas line via graphite ferrules and gradually pressurized up to 1-50 pounds per square inch absolute (psia) (7 to 345 kPa). After pressurizing, any remaining solution was then decanted; and the coated substrate was placed inside a sealed aging vessel [in this case, a 1-inch (2.5-cm) outer-diameter stainless-steel tube] and heated to 60° C. overnight.

### Example 3

For the low- and moderate-temperature applications, a polyvinyl alcohol (PVA) layer can be solution-cast on top of the fine-pore-size silica gel layer. During this PVA coating process, hydrophilic PVA filled up all pore structures in the silica gels and porous supports. After drying overnight, the silica gel layer was re-coated on top of the PVA layer. The main purpose of the top silica gel layer is to protect the unstable PVA layer at elevated temperatures. These alternating layers of silica gel and PVA were repeatedly coated until the gas impermeability through the membranes was confirmed at 1-50 psia.

### Example 4

A typical daily run log for the water recovery experiment is shown in Table I. This particular membrane module included three silica gel layers. As shown in this table, the overall water-recovery experiments ran very smoothly, and water-recovery efficiencies above 90% were achieved consistently. This membrane module was tested over 15 days, typically for 8 hours a day, at various experimental conditions; and there was no apparent degradation in the membrane performance over time.

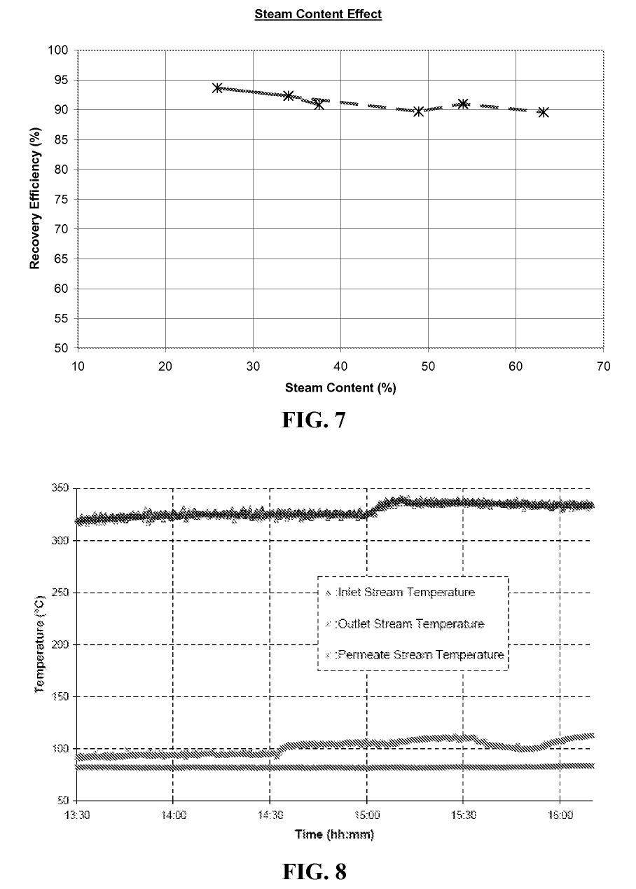

As shown in FIG. 7, extremely high water-recovery efficiencies, consistently above 90%, were achieved by using the produced water-permselective membranes in wide ranges of the steam content from 25% (near a PEMFC cathode exhaust) to 63% (near a SOFC anode exhaust) at a process-stream temperature of 180° C. at the entrance to the membrane module.

### Example 5

The water-permselective-membrane-based technology described herein also can be used as a heat exchanger to preheat incoming air, which can be used as cathode air for fuel cells and as oxidant feedstock for autothermal-reforming or partial-oxidation fuel processing. As shown in FIG. 8, the hot temperature of the gas-feed stream entering the membrane module reduced significantly from 340° C. (top line) at the inlet to 83° C. (bottom line) at the outlet as significant heat is transferred to the permeate air/steam mixture stream (110° C., middle line). This experimental result implies that the water-recovery technology and process, described herein, can be used for both water recovery as well as for heat-exchange operations with extremely high efficiencies.

TABLE I
A Summary of the Typical Run Log for the Water Recovery Experiments.

| Fixed Parameters | | | | | |
|---|---|---|---|---|---|
| Date | Jan. 3, 2007 | Jan. 3, 2007 | Jan. 3, 2007 | Jan. 3, 2007 | Jan. 3, 2007 |
| Start Time | 9:00 | 9:30 | 10:00 | 10:30 | 11:00 |
| End Time | 9:30 | 10:00 | 10:30 | 11:00 | 11:30 |
| Total Run Time [min.] | 30 | 30 | 30 | 30 | 30 |
| Process Parameters | | | | | |
| Water Collected (membrane) (mL) | 16.0 | 16.3 | 16.0 | 16.5 | 15.7 |
| Water Collected (exhaust) (mL) | 1.0 | 1.0 | 1.2 | 1.2 | 1.3 |
| Stream Inlet Temp. (° C.) - T in | 225.0 | 226.0 | 225.0 | 225.0 | 226.0 |
| Stream Exhaust Temp. (° C.) - T out | 75.0 | 75.0 | 74.0 | 74.0 | 74.0 |
| Sweep Exhaust Temp. (° C.) - T sw | 90.0 | 91.0 | 89.0 | 89.0 | 91.0 |
| Calculated Values | | | | | |
| Collection Efficiency (%) | 94.1 | 94.2 | 93.0 | 93.2 | 92.4 |
| Steam Content, vol % | 58.4 | 58.8 | 58.9 | 59.6 | 58.6 |
| Bypass Air Flowrate (mL/min) | 502.1 | 502.1 | 498.3 | 498.3 | 497.9 |
| Air Sweep Flowrate (mL/min) | 536.2 | 536.2 | 542.0 | 542.0 | 561.3 |

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/20^{th}, 1/10^{th}, ⅕^{th}, ⅓^{rd}, ½, etc., or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including patents and patent applications, cited throughout this application are hereby incorporated by reference in their entirety. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

1. A water-permselective membrane comprising:
a porous support; and
a hydrophilic active-membrane material, wherein pores of the porous support are filled or coated with the hydrophilic active-membrane material, rendering the water-permselective membrane substantially impermeable to non-polar gases at a pressure gradient of at least 70 kPa across the water-permselective membrane when the hydrophilic active-membrane material is wet, the hydrophilic active-membrane material being selectively permeable to water.

2. The water-permselective membrane of claim 1, wherein the hydrophilic active-membrane material is a solid or a gel.

3. The water-permselective membrane of claim 1, wherein the hydrophilic active-membrane material includes a hydrophilic nanoporous inorganic gel.

4. The water-permselective membrane of claim 3, wherein the average pore size of the hydrophilic nanoporous inorganic gel is below 100 nm.

5. The water-permselective membrane of claim 3, wherein the hydrophilic nanoporous inorganic gel comprises silica.

6. The water-permselective membrane of claim 5, wherein nanoparticles comprising a zeolite or a hydrophilic polymer are contained in the hydrophilic nanoporous inorganic gel.

7. The water-permselective membrane of claim 1, wherein the hydrophilic active-membrane material comprises a hydrophilic polymeric material that is stable at temperatures of at least 100° C.

8. The water-permselective membrane of claim 7, wherein the hydrophilic polymeric material is selected from sodium carboxymethyl cellulose and poly(vinyl alcohol).

9. The water-permselective membrane of claim 1, wherein the hydrophilic active-membrane material includes nanocomposite structures of inorganic and organic hydrophilic materials.

10. The water-permselective membrane of claim 9, wherein the nanocomposite structures include molecular sieve carbon embedded with titania or zeolite.

11. The water-permselective membrane of claim 1, wherein the hydrophilic active-membrane material comprises a cross-linked polyacrylamide copolymer.

12. The water-permselective membrane of claim 1, wherein the hydrophilic active-membrane material is substantially impermeable to non-polar gases at pressure gradients up to 345 kPa when wet.

13. A process of extracting a polar substance from a gas mixture comprising:
providing a polar-substance-permselective membrane comprising:
a) a porous support; and
b) a hydrophilic or hydrophobic active-membrane material, wherein pores of the porous support are filled or coated with the active-membrane material to render the polar-substance-permselective membrane substantially impermeable to non-polar gases at a pressure gradient of at least 70 kPa across the substance-permselective membrane when the active-membrane material is wet, the active-membrane material being selectively permeable to a polar substance;
flowing a gas mixture across the surface of the polar-substance-permselective membrane in contact with the hydrophilic active-membrane material, a pressure gradient of at least 70 kPa existing across the polar-substance-permselective membrane;
allowing a polar substance from the gas mixture to adsorb to the active-membrane material and to be transported across the polar-substance-permselective membrane; and
collecting and removing the polar substance from a permeate side of the polar-substance-permselective membrane opposite from the surface across which the gas mixture flows.

14. The process of claim 13, wherein the gas mixture is at a temperature of at least about 100° C.

15. The process of claim 13, wherein the gas mixture is at a temperature of at least about 200° C.

16. The process of claim 13, wherein the gas mixture comprises steam and inert gas.

17. The process of claim 13, wherein the polar substance is water and the active-membrane material is hydrophilic.

18. The process of claim 17, wherein the water is removed as steam from the polar-substance-permselective membrane.

19. The process of claim 18, further comprising using the steam that is removed from the polar-substance-permselective membrane in a process for converting liquid hydrocarbons into hydrogen-rich gas streams.

20. The process of claim 13, wherein the polar substance is ethanol or acetone and the active-membrane material is hydrophobic.

21. The process of claim 13, wherein the polar substance is removed by sweeping a fluid over the permeate surface of the polar-substance-permselective membrane.

22. The method of claim 21, wherein the fluid is selected from air, alcohol and salt.

23. A polar-substance-permselective membrane comprising:
a porous support; and
a hydrophilic or hydrophobic active-membrane material, wherein pores of the porous support are filled or coated with the active-membrane material to render the polar-substance-permselective membrane substantially impermeable to non-polar gases at a pressure gradient of at least 70 kPa across the polar-substance-permselective membrane when the active-membrane material is wet, the active-membrane material being selectively permeable to a polar substance.

24. The water-permselective membrane of claim 1, wherein the hydrophilic active-membrane material is substantially impermeable to non-polar gases at pressure gradients up to 690 kPa when wet.
